(19) United States
(12) Patent Application Publication
(10) Pub. No.: US 2010/0223141 A1
(43) Pub. Date: Sep. 2, 2010

(54) Differential Buying Channels for Online Advertising

(75) Inventors: Scott Spencer, New York, NY (US); Rahul Bafna, New York, NY (US); Wayne W. Lin, San Francisco, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/394,835

(22) Filed: Feb. 27, 2009

(51) Int. Cl. G06Q 30/00

(52) U.S. Cl. 705/14.71; 705/26

(57) ABSTRACT

Systems and methods for adjusting bids based upon differential buying channels. A first buying channel and a second buying channel for an advertisement can be compared. If a revenue share from the first buying channel and second buying channel differ, the bid for the advertisement on the buying channel with the higher revenue share can be discounted based upon the difference. A winning bid can be identified using the discounted bid and the bid associated with the lower of the two revenue shares.

### BACKGROUND

This disclosure is related to advertisement buying and selling exchanges.

The rise of the Internet has enabled access to a wide variety of content items, e.g., video and/or audio files, web pages for particular subjects, news articles, etc. Such access to these content items has likewise enabled opportunities for targeted advertising. For example, content items of particular interest to a user can be identified by a search engine in response to a user query. The query can include one or more search terms, and the search engine can identify and, optionally, rank the content items based on the search terms in the query and present the content items to the user (e.g., according to the rank). This query can also be an indicator of the type of information of interest to the user. By comparing the user query to a list of keywords specified by an advertiser, it is possible to provide targeted advertisements to the user.

Another form of online advertising is advertisement syndication, which allows advertisers to extend their marketing reach by distributing advertisements to additional partners. For example, online publishers can place an advertiser's text or image advertisements in advertisement slots on web pages that have content related to the advertisement. As the users are likely interested in the particular content on the publisher webpage, they are also likely to be interested in the product or service featured in the advertisement. Accordingly, such targeted advertisement placement can help drive online customers to the advertiser's website.

Both the search engine publishers and syndication publishers provide advertisements in advertising slots that are sold to advertisers. For example, publishers can use an advertising exchange to sell their advertising slots. An advertising exchange can aggregate advertising slots from many different ad slot sales networks (e.g., Google AdSense) and publishers. Moreover, an advertising exchange can facilitate an advertiser purchasing an advertisement slot from ad slot sales networks or publishers that the advertiser might otherwise be ineligible to purchase. Advertising exchanges, ad slot purchasing networks and ad slot sales networks can all charge fees to the advertisers and/or publishers based upon the sale of advertising slots on the exchange. When a bid from an advertising network is submitted to an advertising exchange, the advertising network can discounts the bid to account for a purchase brokering share for the advertising network. Similarly, the advertising exchange can charge a revenue share for providing a medium through which the advertisement slot is sold, and the ad slot sales network can charge a sales brokering share for selling the advertising slot. The remainder of the bid can be disbursed to the publisher selling the advertising slot. However, existence of multiple advertising networks belonging to the exchange can tend to disfavor some advertising purchasing channels over others based upon different revenue shares charged by the purchasing channels.

### SUMMARY

Systems, methods and computer readable media for accounting for differential buying channels are provided. In an aspect, a method includes receiving first bid data defining a first bid for a placement through a first channel, the first channel having a first revenue share percentage; receiving second bid data defining a first bid for the placement through a second channel, the second channel having a second revenue share percentage; determining an adjustment value based on the first and second revenue share percentages; discounting the bid associated with a higher of the first and second revenue share percentages based on the adjustment value; and generating winning bid data that identifies a winning bid for the placement from the discounted bid and the bid associated with a lower of the first and second revenue share percentages. Other embodiments of this aspect include corresponding systems, apparatus, and computer program products.

In another aspect, a method includes receiving bid data defining a plurality of bids for a placement, each of the bids being associated with a buying channel and each buying channel having an associated revenue share percentage; identifying a minimum revenue share percentage from the plurality of revenue share percentages; for each of the buying channels having a revenue share percentage higher than the minimum revenue share percentage: determining an adjustment value based on the minimum revenue share percentage and the revenue share percentage of the buying channel and discounting the bid associated with the buying channel based on the adjustment value; and generating winning bid data that identifies a winning bid for the placement from the discounted bids and the bid associated with the lowest of the revenue share percentages. Other embodiments of this aspect include corresponding systems, apparatus, and computer program products.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a block diagram of an example network architecture that can provide bid adjustment based upon differential buying channels.

FIG. 2 is a block diagram of an example advertising exchange illustrating differential buying channels.

FIG. 3 is a block diagram of an example advertising exchange with a differential buying channel bid adjustment component.

FIG. 4 is a flowchart of an example process of adjusting bids for differential buying channels.

FIG. 5 is block diagram of an example computer system.

### DETAILED DESCRIPTION

Differential buying channels can exist when an advertising exchange is used to sell advertising slots to advertisers. For example, when an advertisement slot is sold on an advertising exchange, an advertiser from a purchasing network can purchase the advertisement slot through multiple channels (e.g., through an ad slot purchasing network and through the advertising exchange). The existence of multiple buying channels for advertisement slots can lead to unfair results in bidding, because a first channel and second channel are charging different revenue shares for the bidding process. A differential buying channel bid adjustment component can compare the revenue shares of a first and second buying channel to determine whether the revenue share associated with one of the buying channels is lower than that of the other buying channel. The buying channel with the higher revenue share can be identified, and a discount can be applied to bids submitted through the buying channel with the higher revenue share in order to provide a more fair allocation of bids associated with the buying channel having the higher revenue share.

Although various examples are described with reference to an economic mechanism for providing advertisements, the systems and methods described in this specification can also be used as the basis for economic mechanisms for other types of content items, such as videos, articles, reviews, etc.

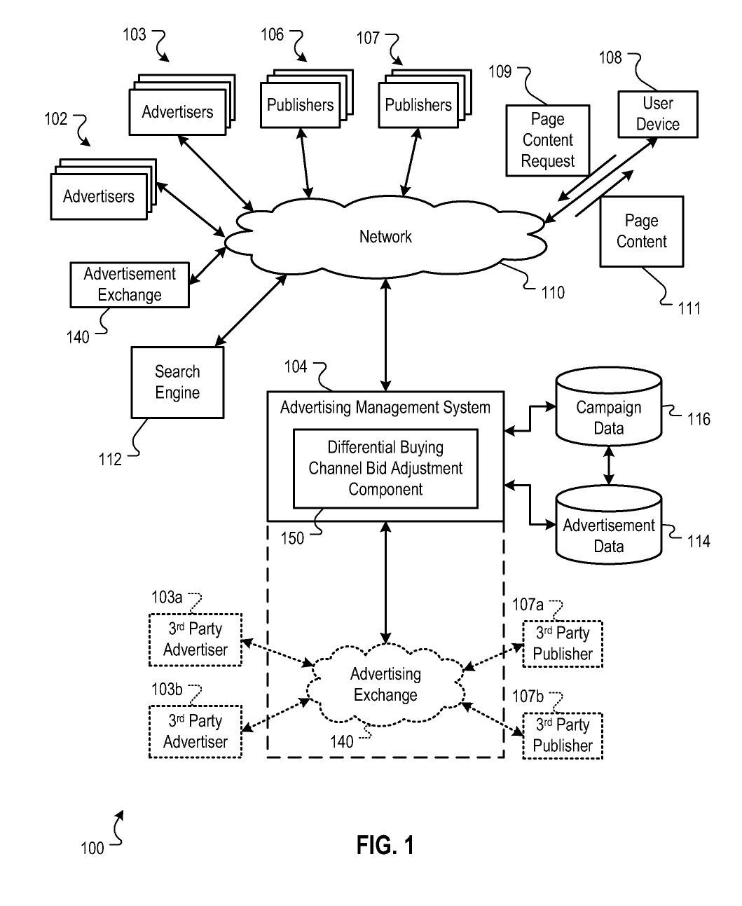

The subject matter of this specification can be implemented in an online environment, such as the example online environment 100 shown in FIG. 1. The online environment 100 can facilitate the identification and serving of content items, e.g., web pages, advertisements, etc., to users. A computer network 110, such as a local area network (LAN), wide area network (WAN), the Internet, or a combination thereof, connects advertisers 102 and 103, an advertising management system 104, publishers 106 and 107, and a search engine 112, and a user device 108. The online environment 100 may include many thousands of advertisers, publishers and user devices.

### 1.0 Advertisement Publishing and Tracking

In the online environment 100, advertisers 102 can directly, or indirectly, enter, maintain, and track online advertisement information in the advertising management system 104. The online advertisements can be in the form of graphical advertisements, such as banner advertisements, text only advertisements, image advertisements, audio advertisements, video advertisements, advertisements combining one of more of any of such components, etc., or any other type of electronic advertisement 120. The advertisements may also include embedded information, such as a links, meta-information, and/or machine executable instructions, such as HTML or JavaScript™.

The user device 108 can submit a page content request 109 to a publisher or the search engine 112. In some implementations, the page content 111 can be provided to the user device 108a in response to the page content request 109. The page content can include advertisements provided by the advertising management system 104, or can include executable instructions, e.g., JavaScript™, that can be executed at the user device 108 to request advertisements from the advertising management system 104. Example user devices 108 include personal computers, mobile communication devices, television set-top boxes, etc.

Advertisements can also be provided using the search engine 112. The search engine 112 can receive queries for search results. In response, the search engine 112 can retrieve relevant search results from an index of documents (e.g., from an index of web pages). The search engine 112 can also submit a request for advertisements to the system 104. The request may include a number of advertisements desired. This number may depend on the search results, the amount of screen or page space occupied by the search results, the size and shape of the advertisements, etc. The search engine 112 can combine the search results with one or more of the advertisements provided by the system 104 and forward the combined page to the user device 108.

The advertisers 102, user devices 108, and/or the search engine 112 can also provide usage information to the advertising management system 104. This usage information can include measured or observed user behavior related to advertisements that have been served, such as, for example, whether or not a conversion or a selection related to an advertisement has occurred. The user behavior of selecting an advertisement can be referred to as an online response to the advertisement, e.g., a click-through. In some implementations, the system 104 can perform financial transactions, such as crediting the publishers 106 and charging the advertisers 102 based on the usage information. Such usage information can also be processed to measure performance metrics, such as a click-through rate (“CTR”), conversion rate, and other measurable performance metrics for online responses.

### 1.1 Advertisement Auctioning and Management

In addition to the advertisements being selected based on content such as a search query or web page content of a publisher, the advertisements can also be selected from other selection processes, such as an auction. In one implementation, the advertising management system 104 includes an auction process. Advertisers 102 may be permitted to select, or bid, an amount the advertisers are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of an advertisement based on a keyword. For example, advertisers A, B, and C all select, or bid, a maximum cost-per-click of $0.50, $0.75, and $1.00, respectively. The maximum amount advertiser A will pay for a click is $0.50, the maximum amount advertiser B will pay is $0.75, and the maximum amount advertiser C will pay is $1.00.

The position, or rank, of an advertisement, such as where the advertisement is displayed next to search results or in which slot an advertisement will be displayed on a publisher page, can be a function of the cost-per-click multiplied by a quality score associated with the advertisement. A quality score can be the basis for measuring the quality and relevance of an advertisement. The quality score can, for example, be determined by the advertisement's click-through rate, the relevance of the advertisement text, overall historical keyword performance, and the user experience on a landing page associated with the advertisement. Other parameters can also be used to determine a quality score. The rank of an advertisement that is displayed can be determined by multiplying the maximum cost-per-click for the advertisement by a quality score of the advertisement.

The advertisements, associated usage data, and bidding parameters described above can be stored as advertisement data in an advertisement data store 114. An advertiser 102 can further manage the serving of advertisements by specifying an advertising campaign. The advertising campaign can be stored in campaign data in a campaign data store 116, which can, for example, specify advertising budgets for advertisements, and when, where and under what conditions particular advertisements may be served for presentation, etc.

In some implementations, these advertisers 102 associated with the advertising management system 104 can bid on advertising slots being auctioned on an advertising exchange 140. Advertising slots being sold on the advertising exchange 140 can also be bid upon by third-party advertisers 103, e.g., advertisers that are not affiliated with the advertisement management system 104. In some implementations, the third-party advertisers 103 can bid on advertising slots being auctioned on the advertising exchange through an ad slot purchasing network. For example, ad slot purchasing networks can include, for example, Google AdSense provided by Google Inc. of Mountain View, Calif.

In some implementations, advertiser specified bids submitted to the advertising exchange 140 through an ad slot purchasing network can be discounted prior to submission of the bid to the advertising exchange. Bids can be discounted to account for a purchase brokering revenue share being charged to the advertiser by the ad slot purchasing network, thereby preventing the price paid for the advertising slot from exceeding a maximum bid specified by the advertiser. For example, if an advertiser specifies a maximum bid of $2.00, and the purchase brokering revenue share charged by the ad slot purchasing network is 50%, the bid can be discounted to $1.00 before submitting the bid to the advertising exchange. Thus, the maximum winning bid on the advertising exchange for the advertiser will be $1.00, ensuring that when the purchase brokering revenue share is applied, the price paid by the advertiser does not exceed $2.00 (e.g., Cost=Winning Bid*1/(1−Revenue Share)=$1.00*1/(1−0.5)=$2.00).

The advertising slots to be sold on the advertising exchange 140 can be supplied by the publishers 106 associated with the advertising management system 104. Alternatively, advertising slots sold on the advertising exchange 140 can be supplied by third-party publishers 107 not associated with the advertising management system 104. In some implementations, the third-party publishers 107 can provide advertising slots to the advertising exchange 140 through one or more ad slot sales networks (e.g., Google AdSense, available from Google, Inc. of Mountain View, Calif.). The ad slot sales networks can aggregate advertising slots for sale on the advertising exchange 140. The ad slot sales networks can charge a sales brokering share to publishers 106 and 107 for selling the advertising slot on the advertising exchange 140.

In addition to the brokering shares paid by advertisers and publishers to buying and selling, respectively, advertisement space on the advertising exchange, the advertising exchange 140 can charge a revenue share for using the exchange. In some examples, the advertising exchange might charge a revenue share of 10% on the winning bid for an advertising slot sold. Thus, if an advertising slot is sold for $1.00, the advertising exchange can take of $0.10 from the winning bid before distributing the remainder ($0.90) to the publisher (or ad slot sales network).

Differential buying channels exist for an advertiser 102 to purchase an advertisement slot being sold on the advertising exchange 140 from a publisher 108. For example, the advertisement slot can be purchased for a negotiated revenue share between an ad slot sales network and an ad slot purchasing network, but third party advertisers pay a different revenue share to the exchange 140 for purchasing the advertising slot. Submission of bids from advertisers that also use a higher revenue share channel without discounting the bids would tend to bias the auction in favor of the bid received from the buying channel having the higher revenue share. Thus, the bid associated with a buying channel having a higher revenue share can be discounted to minimize or remove this bias.

To facilitate these discounts, the advertising management system 104 includes a differential buying channel bid adjustment component 150. The differential buying channel bid adjustment component 150 can adjust the bid submitted to an advertising exchange 140. The bid associated with a buying channel having a higher revenue share can be discounted when that bid is provided to the advertising exchange 140, thereby more fairly accounting for the advertisement bid that typically used for the buying channel having the higher revenue share. For example, an advertiser 102 might bid on an advertisement slot provided by publisher 106. However, if the advertisement is on the exchange 140, it is subject to bidding by third party advertisers 103. If the advertising exchange 140 charges a different revenue share than would be charged by the advertising management system 104, the advertisers 102 might be unfairly advantaged in an auction if their bids are submitted without discounting. At the same time, discounting the by the entire revenue share associated with the advertising management system 104 would be unfair to advertisers 102 and publishers 106 if the advertisement slot were sold within the network provided by the advertising management system 104. Methods for discounting the bid submitted to the advertising exchange 140 are detailed below.

### 2.0 Example Bid Discount Process for Differential Buying Channels

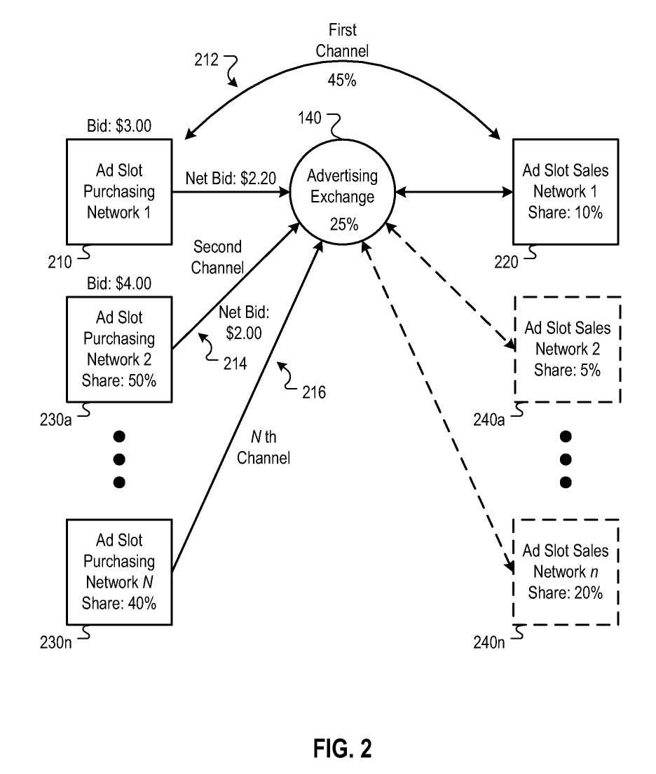

FIG. 2 is a block diagram of an example advertising exchange 140 illustrating differential buying channels. Bids are discounted based on based on the revenue share percentages associated with each buying channel available to advertisers. The percentages used in FIG. 2 are examples, and other percentages can be used.

An advertiser that is a member of a first ad slot purchasing network 210 can buy advertising space through a first buying channel 212 having a revenue share of 45%. The first buying channel is a buying channel that does not use the advertising exchange 140 (e.g., a buying channel direct to the sales network 220).

The advertising exchange 140 has a revenue sharing percentage of 25%. Thus, an advertiser that is a member of a second ad slot purchasing network 230 (e.g., network 230a) that purchases the advertising space from the sales network 220 over a second buying channel 214 to the advertising exchange 140 pays a 25% revenue share to the advertising exchange 140.

If the advertiser that is a member of a first ad slot purchasing network 210 purchases through the advertising exchange 140, the bids associated with the higher revenue share buying channel (i.e., the first buying channel 212) that are provided to the advertising exchange 140 can be discounted by an adjustment value before submission to the advertising exchange 140. However, discounting bids associated with the higher revenue share buying channel (e.g., the first buying channel 212) by the entire amount of the higher revenue share would unfairly advantage the bids received through the lower revenue share buying channel (e.g., second buying channel 214).

Thus, in some implementations, the bids associated with the higher revenue share are discounted by a rate such that the compounded net rate compensates for the difference between the higher revenue share buying channel 212 and the lower revenue share buying channel 214. Such a compounded net rate is referred to as a “compounded to neutrality” rate. Such a discount attempts to effectively allocate a portion of the ad network revenue share for the first buying channel 212 to the ad slot sales network 210, and allocates the remainder of the revenue share to the advertising exchange 140, thereby putting bids from the first ad slot purchasing network 210 and bids from the second ad slot purchasing network 230a on more even footing.

The revenue shares a first buying channel 212 and a second buying channel 214 are compared to determine whether a revenue share associated with the first buying channel 212 is greater than a revenue share associated with the second buying channel 214. In the example of FIG. 2, the revenue share of the first buying channel is 45%, and the revenue share of the second buying channel is 25%. Because the revenue share associated with the first buying channel 212 is greater than the revenue share associated with the second buying channel 214 (45%>25%), the bid submitted by the first advertising network 210 to the advertising exchange 140 is discounted.

In some implementations, the discount applied to the bid submitted by the first advertising network 210 is based on an adjustment value that is function of the revenue share of the first buying channel and the revenue share of the second buying channel. In some implementations, this function is based on a ratio of the first discount based on a highest revenue share percentage to a second discount based on a lowest revenue share percentage. An example function is given by the following formula:

$$CNR = 1 - \frac{1 - {RV}_{h}}{1 - {RV}_{1}}$$

### Where:

CNR=Compounded Net Rate adjustment value

RVₕ=Highest revenue share of two buying channels

RVₗ=Lowest revenue share of two buying channels

For example, with RVₕ=45%, RVₗ=25%:

CNR=1−(1−0.45)/(1−0.25)=1−0.733=0.267

Accordingly, the $3.00 bid associated with the first buying channel is discounted by 26.7%, i.e., $3.00*0.733=$2.20. As the advertiser on the second advertising network 230a submits a maximum price of $4.00, and the second advertising network 230a charges a 50% share to the advertiser, the bid submitted to the advertising exchange is discounted to ensure that the winning bid does not exceed the maximum price specified by the advertiser after the 50% ad slot purchase brokering share is applied. In this example, the discounted bid submitted to the advertising exchange 140 is $2.00 (e.g., Max Bid=Max Price*(1−Revenue Share)=$4.00*(1−0.50)=$2.00). Accordingly, in this example, the discounted bid submitted to the advertising exchange 140 by the first advertising network ($2.20) wins the auction.

In some implementations, a second price auction system is used. In a second price auction, the winning bid is set to a value that is incrementally higher than the next highest bid. In the example shown, a second price auction would yield a winning bid of $2.01, where $2.00 is the next highest bid, and $2.01 is incrementally higher than the next highest bid.

In some implementations, the price paid by the advertiser for the winning bid is identified by the equation:

$$Advertiser Cost = WB \times \frac{1}{1 - ( {R}_{diff} )}$$

### Where:

WB is the winning bid; and

R_{diff} is the difference between the higher and lower revenue shares of the first and second buying channels 212, 214. In the example provided in FIG. 2, the advertiser cost is $2.51 (i.e., $2.01*1/(1−0.2)=$2.51). In other implementations, the CNR value can be used instead of the value of R_{diff}.

A net exchange price paid to the ad slot sales network 220 for the advertisement slot is the winning bid discounted by 25% (e.g., $2.01*0.75=$1.51), per the advertising exchange revenue share.

If the sales network charges a revenues share, then that share is also discounted for the publisher. In this example, the ad slot sales network 220 charges the publisher a 10% share for the sale, and thus the publisher is paid a net publisher share of $1.36 for the advertisement slot ($1.51*0.9).

Although the above example provides a particular formula for the compounded net rate that results in a neutral bias (i.e., the buying channels are essentially unbiased in bidding relative to each other), other adjustment values can be used to discount the bids. For example, the adjustment value can be based on the difference between the first and second revenue share percentages, e.g., 1−RVₕ+RVₗ. Such an adjustment value may result in a bias to one channel, but nevertheless reduces the bias that results from not applying any discounts.

Although the above example has been described with reference to two buying channels, the process can be applied to multiple channels. For example, a plurality of bids for a placement can be received and each of the bids can be associated with a buying channel. Each buying channel has an associated revenue share percentage. A minimum revenue share percentage from the plurality of revenue share percentages can be identified, and bids associated with each of the higher revenue share percentages can be discounted based on each bid's respective associated revenue share percentage and the minimum revenue share percentage as describe above. The winning bid for the placement from the discounted bids and the bid associated with the lowest of the revenue share percentages can thus be identified as described above, as can the various shares and net proceeds.

For example, assuming there are n buying channels, the adjusted bid for each buying channel is based on the compounded net rate:

$${CNR}_{i} = 1 - \frac{1 - {RV}_{h , i}}{1 - {RV}_{1}}$$

CNRᵢ=Compounded Net Rate for an i^{th} buying channel

RV_{h,i}=Revenue share of the i^{th} buying channel

RVₗ=The lowest revenue share of all n buying channels.

Other factors can also be used to adjust bids. For example, a quality score associated with an advertiser or publisher can be used to further adjust the bids or the effect of the bids in an auction. The quality score can be based on the performance of the advertiser's advertisements or the performance of advertisements published on a publisher page, or both. The quality score is indicative of the value of a given advertisement on a given publisher page, and can be based on click-through rates, conversion rates, or other performance metrics.

### 3.0 Differential Buying Channel Bid Adjustment

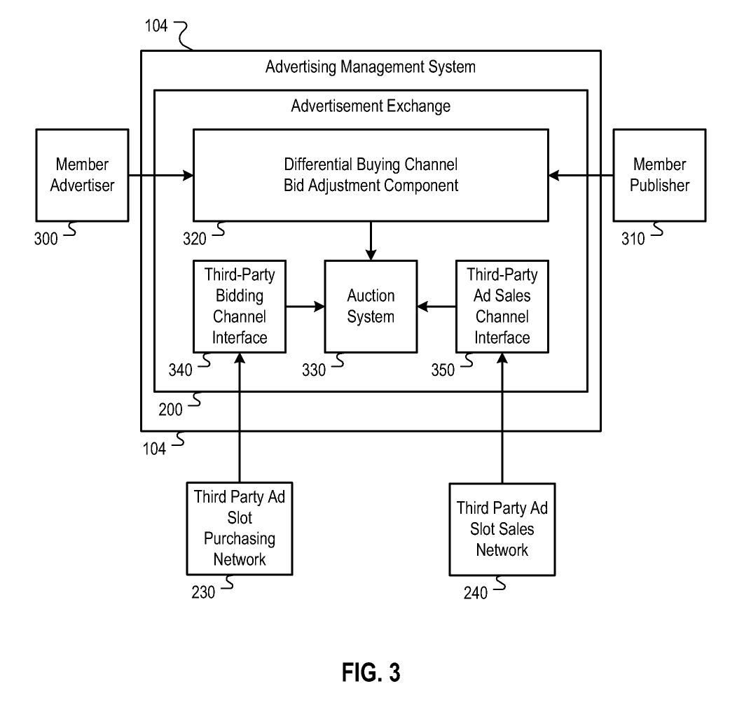

FIG. 3 is a block diagram of an example advertising exchange 140 with a differential buying channel bid adjustment component 320. In some implementations, the advertising exchange 140 can be a component of an advertising management system 104. Bids from member advertisers 300 and slots from member publishers 310 can be received by the differential buying channel bid adjustment component 320. The differential buying channel bid adjustment component 320 can provide adjusted bids to an auction system 330.

In some implementations, the differential buying channel bid adjustment component 320 can adjusted bids before the bids are submitted to the auction system 330 by discounting the bids based upon a difference between the revenue share charged to member advertisers 300 and the revenue share charged by the advertising exchange 140. An example discounting systems are described with reference to FIG. 2. Other discounting systems can be used.

In some implementations, the auctioning system 330 can also receive bids from advertisers through a third party ad slot purchasing network 230 and a third-party bidding channel interface 340. For example, if an advertiser that is not a member of the advertising network associated with the advertising management system 104 wants to submit a bid on an advertising slot being sold on the advertising exchange 140, the advertiser's bid can be submitted through the third-party bidding channel interface.

In some implementations, the auctioning system 330 can also receive advertising slots for sale on the advertising exchange 140 from publishers through a third-party ad slot sales network 240 and a third-party ad buying channel interface 350. For example, if a publisher that is not a member of the advertising network associated with the advertising management system 104 wants to submit an advertising slot for sale on the advertising exchange 140, the publisher's advertising slot can be submitted through the third-party ad buying channel interface 350.

### 4.0 Example Bid Adjustment for Differential Buying Channels

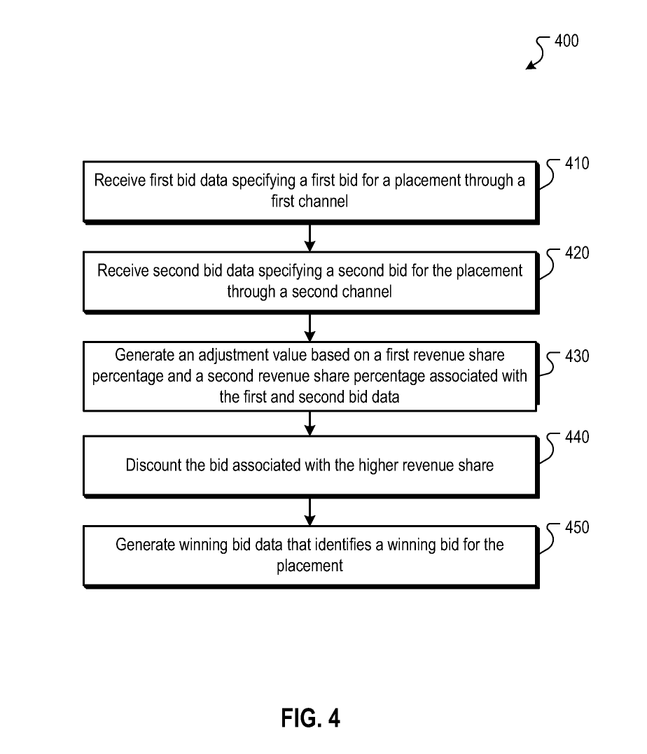

FIG. 4 is a flowchart of an example process 400 of adjusting bids for differential buying channels. The example process 400 can be applied to an exchange that receives bids from multiple channels having different revenue share percentages.

At stage 410, first bid data defining a first bid for a placement through a first channel is received. The first bid for placement through a first channel can be received, for example, by a differential buying channel bid adjustment component (e.g., differential buying channel bid adjustment component 320 of FIG. 3). In some implementations, the bid is received from an advertiser that is a member of an advertising management system associated with the differential buying channel bid adjustment component. The first bid data has an associated revenue share percentage.

At stage 420, second bid data defining a first bid for the placement through a second channel can be received. The second bid for the placement can be received, for example, by an advertising exchange (e.g., advertising exchange 140 of FIGS. 2 and 3). In some implementations, the bid received by the advertising exchange can be provided by a third party advertising network. The second bid data has an associated revenue share percentage.

At stage 430, and adjustment value based on a first revenue share percentage and a second revenue share percentage associated with the first and second bid data is generated. The adjustment value can be a compounded net rate calculated by a differential buying channel bid adjustment component (e.g., differential buying channel bid adjustment component 320 of FIG. 3). In some implementations, the compounded net rate can be generated according to the CNR formulas above.

At stage 440, the bid associated with the higher revenue share is discounted. The bid associated with the higher revenue share can be discounted, for example, by a differential buying channel bid adjustment component (e.g., differential buying channel bid adjustment component 320 of FIG. 3). In some implementations, the bid is discounted by the compounded net rate. In some implementations, the discounted bid accounts for a difference between the revenue share charged by the network and the revenue share charged by the advertising exchange.

At stage 450, winding bid data is generated that identifies a winning bid for the placement. The winning bid can be identified, for example, by an auction system (e.g., auction system 330 of FIG. 3). In some implementations, the auction system can implement a second price auction system, whereby the winning bid is defined by an incremental increase over the next highest maximum bid. In further implementations, the price charged to the advertiser can be the winning bid multiplied by the difference between the maximum and minimum revenue shares. Moreover, the price paid to the ad slot sales network providing the slot can be identified by multiplying the winning bid by the ad exchange share. The difference between the price paid by the advertiser or ad slot purchasing network and the amount distributed to the publisher or ad slot sales network can be distributed to the advertising exchange.

### 5.0 Example Computer System

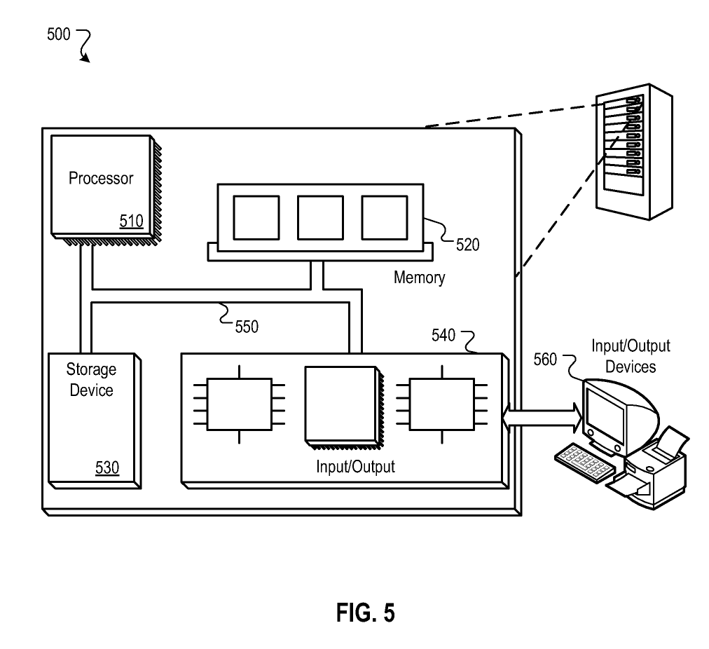

FIG. 5 is block diagram of an example computer system 500. The system 500 includes a processor 510, a memory 520, a storage device 530, and an input/output device 540. Each of the components 510, 520, 530, and 540 can, for example, be interconnected using a system bus 1350. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The advertising management system 104 and/or differential buying channel bid adjustment component 150, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium. The advertising management system 104 and/or differential buying channel bid adjustment component 150, and components thereof, can be distributively implemented over a network, such as a server farm, or can be implemented in a single computer device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
receiving first bid data defining a first bid for a placement through a first channel, the first channel having a first revenue share percentage;
receiving second bid data defining a first bid for the placement through a second channel, the second channel having a second revenue share percentage;
determining an adjustment value based on the first and second revenue share percentages;
discounting the bid associated with a higher of the first and second revenue share percentages based on the adjustment value; and
generating winning bid data that identifies a winning bid for the placement from the discounted bid and the bid associated with a lower of the first and second revenue share percentages.

2. The computer-implemented method of claim 1, further comprising determining a price to be paid by an advertiser that submitted the winning bid based on a multiplication of the winning bid data by the inverse of the quantity of one minus a difference between the first and second revenue share percentages.

3. The computer-implemented method of claim 2, further comprising determining a net exchange price based on the winning bid and an exchange revenue share percentage.

4. The computer-implemented method of claim 2, further comprising:
determining a net exchange price based on a multiple of the winning bid data and an exchange revenue share percentage;
determining a publisher network share of the net exchange price based on a multiple of the net exchange price and a publisher network revenue share percentage; and
subtracting the publisher network share from the price paid to the publisher network to determine an amount due to the publisher.

5. The computer-implemented method of claim 4, further comprising determining a publisher share based on the difference between the net exchange price and the publisher network share, the publisher share being due to a publisher providing the placement.

6. The computer-implemented method of claim 1, wherein the second channel comprises a plurality of third-party placement purchasing channels.

7. The computer-implemented method of claim 1, wherein determining an adjustment value based on the first and second revenue share percentages comprises determining the difference between the first and second revenue share percentages.

8. The computer-implemented method of claim 1, wherein determining an adjustment value based on the first and second revenue share percentages comprises determining a ratio of a first discount based on a highest of the first and second revenue share percentages to a second discount based on a lowest of the first and second revenue share percentages.

9. The computer-implemented method of claim 1, wherein determining an adjustment value based on the first and second revenue share percentages comprises determining a compounded net rate based on the first and second revenue share percentages that results in a neutral bias of the first and second channels.

10. Computer-readable media having instructions stored thereon, which, when executed by a processor, causes the processor to perform operations comprising
receiving first bid data defining a first bid for a placement through a first channel, the first channel having a first revenue share percentage;
receiving second bid data defining a first bid for the placement through a second channel, the second channel having a second revenue share percentage;
determining an adjustment value based on the first and second revenue share percentages;
discounting the bid associated with a higher of the first and second revenue share percentages based on the adjustment value; and
generating winning bid data identifying a winning bid for the placement from the discounted bid and the bid associated with a lower of the first and second revenue share percentages.

11. The computer-readable media of claim 10, wherein the instructions are further operable to cause the processor to perform operations comprising determining a price to be paid by an advertiser that submitted the winning bid based on a multiplication of the winning bid data by the inverse of the quantity of one minus the difference between the first and second revenue share percentages.

12. The computer-readable media of claim 10, wherein the instructions are further operable to cause the processor to perform operations comprising determining a net exchange price based on the winning bid data and an exchange revenue share percentage.

13. The computer-readable media of claim 10, wherein the instructions are further operable to cause the processor to perform operations comprising:
determining a net exchange price based on the winning bid data and an exchange revenue share percentage;
determining a publisher network share of the net exchange price based on a multiple of the net exchange price and a publisher network revenue share percentage; and
subtracting the publisher network share from the price paid to the publisher network to determine an amount due to the publisher.

14. The computer-readable media of claim 13, wherein the instructions are further operable to cause the processor to perform an operation comprising determining a publisher share based on the difference between the net exchange price and the publisher network share, the publisher share being due to a publisher providing the placement.

15. The computer-readable media of claim 14, wherein the instructions are further operable to cause the processor to perform an operation comprising identifying an exchange share based on the difference between the net exchange price and the price paid.

16. The computer-readable media of claim 14, wherein determining an adjustment value based on the first and second revenue share percentages comprises determining a ratio of a first discount based on a highest of the first and second revenue share percentages to a second discount based on a lowest of the first and second revenue share percentages.

17. The computer-readable media of claim 14, wherein determining an adjustment value based on the first and second revenue share percentages comprises determining a compounded net rate based on the first and second revenue share percentages that results in a neutral bias of the first and second channels.

18. A computer-implemented method, comprising:
receiving bid data defining a plurality of bids for a placement, each of the bids being associated with a buying channel and each buying channel having an associated revenue share percentage;
identifying a minimum revenue share percentage from the plurality of revenue share percentages;
for each of the buying channels having a revenue share percentage higher than the minimum revenue share percentage:
determining an adjustment value based on the minimum revenue share percentage and the revenue share percentage of the buying channel;
discounting the bid associated with the buying channel based on the adjustment value; and
generating winning bid data that identifies a winning bid for the placement from the discounted bids and the bid associated with the lowest of the revenue share percentages.

19. The computer-implemented method of claim 13, wherein determining an adjustment value comprises determining a ratio of a first discount based on the revenue share percentage of the buying channel and to a second discount based on the minimum revenue share percentage.

20. The computer-implemented method of claim 18, wherein generating winning bid data further comprises generating winning bid data based on a quality score associated with one of a publisher of the placement or an advertiser.

21. A system, comprising:
a data store storing instructions; and
a data processing apparatus in data communication with the data store and operable to execute the instructions, wherein the instructions cause the data processing apparatus to perform operations comprising:
receiving first bid data defining a first bid for a placement through a first channel, the first channel having a first revenue share percentage;
receiving second bid data defining a first bid for the placement through a second channel, the second channel having a second revenue share percentage;
determining an adjustment value based on the first and second revenue share percentages;
discounting the bid associated with a higher of the first and second revenue share percentages based on the adjustment value; and
identifying a winning bid for the placement from the discounted bid and the bid associated with a lower of the first and second revenue share percentages.
